(19) United States
(12) Patent Application Publication
(10) Pub. No.: US 2001/0024693 A1
(43) Pub. Date: Sep. 27, 2001

(54) Coating film forming method

(76) Inventors: Hideo Morimoto, Osaka (JP); Etsuyuki Ito, osaka (JP)

Correspondence Address: Shanks & Herbert, TransPotomac Plaza, 1033 N. Fairfax Street, Suite 306, Alexandria, VA, 22314, US

(21) Appl. No.: 09/768,806

(22) Filed: Jan. 25, 2001

(30) Foreign Application Priority Data
Jan. 25, 2000 (JP) 2000-015480

(51) Int. Cl. B05D 1/36

(52) U.S. Cl. 427/404; 427/407.1

(57) ABSTRACT

A method is provided for forming high-appearance multi-layer coating films by sequentially providing an undercoating film with a water-based intermediate coat and a topcoat while controlling the imbibing or inversion at each interface between the respective coating films.

The method comprises forming an intermediate coat using a water-based intermediate coating, a metallic base coat using a water-based metallic base coating and a clear coat using a clear coating in that order on a substrate provided with an electrodeposited coat

wherein the water-based intermediate coating contains an aqueous dispersion of amide group-containing acrylic resin particles having a particle diameter of 0.01 to 1.0 μm as obtained by emulsion polymerization of an amide group-containing, ethylenically unsaturated monomer with another ethylenically unsaturated monomer or monomers or monomers.

### FIELD OF THE INVENTION

The present invention relates to a method of forming a metallic coating film on a car body or the like and to a multi-layer coating film obtained by that method.

### PRIOR ART

The amounts of organic solvents evaporated from car coatings in the stage of coating and baking are generally large and, as part of the endeavor to reduce the number of processes required for car coating, studies have been made to prepare a coating in water-based form.

Thus, for example, Japanese Kokai Publication Sho-62-216671 proposes a method comprising applying a water-based intermediate coating containing resin particles and applying a water-based metallic coating without curing the intermediate coating and, after drying or curing, applying a clear coating. However, this method is not sufficiently effective in providing coating films meeting the current demands for high-appearance.

Japanese Kokai Publication Hei-07-53913 discloses a water-based coating which comprises a resin obtained by at least partially neutralizing a polymer derived from an amide group-containing, ethylenically unsaturated monomer, an acid group-containing, ethylenically unsaturated monomer and a hydroxyl group-containing, ethylenically unsaturated monomer, and an aqueous dispersion of carboxyl group-containing acrylic resin particles. However, the workability in forming multi-layer coating films by applying water-based coatings has not been taken into consideration.

### SUMMARY OF THE INVENTION

Accordingly, it is an object of the present invention to provide a method of forming a multi-layer coating film having an attractive appearance by applying a water-based intermediate coating to an undercoating film and further applying a top coating while controlling imbibing and inhibiting phase inversion at each coating film interface.

The invention provides a method of forming a coating film by forming, on a substrate provided with an electrodeposited coating film, an intermediate coating film using a water-based intermediate coating, a metallic base coating film using a water-based metallic base coating and a clear coating film using a clear coating in that order

wherein said water-based intermediate coating comprises an aqueous dispersion of amide group-containing acrylic resin particles obtained by emulsion polymerization of an amide group-containing, ethylenically unsaturated monomer with another ethylenically unsaturated monomer or monomers,

said resin particles having a particle diameter of 0.01 to 1.0 μm.

The invention also provides a method of forming a coating film

wherein the above water-based metallic base coating comprises an aqueous dispersion of the above amide group-containing acrylic resin particles.

The invention further provides a method of forming a coating film

wherein the above water-based metallic base coating comprises an amide group-containing acrylic resin prepared by solubilizing, with a base, an acrylic resin into water,

said acrylic resin being obtained by solution polymerization of 5 to 40% by weight of an amide group-containing, ethylenically unsaturated monomer, 3 to 15% by weight of an acidic group-containing, ethylenically unsaturated monomer and 10 to 40% by weight of a hydroxyl group-containing, ethylenically unsaturated monomer, and the rest of another ethylenically unsaturated monomer or monomers.

The invention further provides a method of forming a coating film

wherein the above clear coating is a solvent-base one, a water-based one or a powder-form one.

The invention still further provides a multi-layer coating film obtainable by any of the above methods.

In the following, the invention is described in further detail.

### DETAIL DESCRIPTION OF THE INVENTION

Intermediate Coating

In the method of forming a coating film according to the invention, a water-based intermediate coating is used for forming an intermediate coating film. This water-based intermediate coating comprises an aqueous dispersion of amide group-containing acrylic resin particles, a film-forming resin, a curing agent, an organic or inorganic color pigment and an extender pigment, among others.

The above-mentioned aqueous dispersion of amide group-containing acrylic resin particles is obtained by emulsion polymerization in an aqueous medium of an amide group-containing, ethylenically unsaturated monomer with another ethylenically unsaturated monomer or monomers. The monomer mixing ratio in this emulsion polymerization is 3 to 40% by weight, preferably 5 to 30% by weight, of an amide group-containing, ethylenically unsaturated monomer and 97 to 60% by weight, preferably 95 to 70% by weight, of the other ethylenically unsaturated monomers, based on the total amount of the ethylenically unsaturated monomers to be used in producing the aqueous dispersion of amide group-containing acrylic resin particles. When the amount of the amide group-containing, ethylenically unsaturated monomer is less than 3% by weight, the viscosity controllability will become worse. When it exceeds 40% by weight, the films obtained will have low water resistance.

As examples of the above amide group-containing, ethylenically unsaturated monomer, there may be mentioned (meth)acrylamide, N-methylol(meth)acrylamide, N,N-dimethyl(meth)acrylamide, N,N-dibutyl(meth)acrylamide, N,N-dioctyl(meth)acrylamide, N-monobutyl(meth)acrylamide and N-monooctyl(meth)acrylamide and the like. Preferred as the amide group-containing, ethylenically unsaturated monomer are acrylamide and methacrylamide, however.

The other ethylenically unsaturated monomer is not particularly restricted but, for causing the amide group-containing acrylic resin particles to contain an acidic group from the viewpoint of workability, among others, an acidic group-containing, ethylenically unsaturated monomer may be used in an amount of 0 to 15% by weight, preferably 0 to 13% by weight. When the amount of the acidic group-containing, ethylenically unsaturated monomer is in excess of 15% by weight, the films obtained will have low water resistance.

The above amide group-containing acrylic resin particles preferably have an acid value within the range of 0 to 100 mg KOH/g, more preferably within the range of 0 to 80 mg KOH/g. When the acid value is above 100 mg KOH/g, the water solubility becomes excessive and the particles may lose their shape.

The above acidic group-containing, ethylenically unsaturated monomer includes carboxyl group-containing, ethylenically unsaturated monomers, for example (meth) acrylic acid derivatives (e.g. acrylic acid, methacrylic acid, crotonic acid, isocrotonic acid, acrylic acid dimer, acrylic acid-caprolactone adduct, namely α-hydro-ω-[(1-oxo-2-propenyl)oxy]poly[oxy(1-oxo-1,6-hexanediyl)], etc.; and unsaturated dibasic acids, half esters, half amides and half thioesters thereof (e.g. maleic acid, fumaric acid and itaconic acid, half esters, half amides and half thioesters thereof).

As other ethylenically unsaturated monomers other than the acidic group-containing, ethylenically unsaturated monomer, there may first be mentioned hydroxyl group-containing, ethylenically unsaturated monomers, specifically 2-hydroxyethyl (meth)acrylate, 2-hydroxypropyl (meth)acrylate, hydroxybutyl (meth)acrylate, allyl alcohol, and methacryl alcohol, 2-hydroxyethyl (meth) acrylate-ε-caprolactone adduct, 2,4-dihydroxy-4′-vinylbenzophenone, N-(2-hydroxyethyl)acrylamide, N-(2-hydroxyethyl)methacrylamide and the like.

As examples of the other ethylenically unsaturated monomers, there may be mentioned (meth) acrylate ester monomers (e.g. methyl (meth)acrylate, ethyl (meth)acrylate, n-butyl (meth)acrylate, isobutyl acrylate, tert-butyl acrylate, 2-ethylhexyl (meth)acrylate, lauryl methacrylate, phenyl acrylate, isobornyl (meth)acrylate, cyclohexyl methacrylate, tert-butylcyclohexyl (meth)acrylate, dicyclopentadienyl (meth)acrylate, dihydrodicyclopentadienyl (meth)acrylate), polymerizable aromatic compounds (e.g. styrene, α-methylstyrene, vinyl ketones, tert-butylstyrene, p-chlorostyrene, vinylnaphthalene), polymerizable nitriles (e.g. acrylonitrile, methacrylonitrile), α-olefins (e.g. ethylene, propylene), vinyl esters (e.g. vinyl acetate, vinyl propionate) and dienes (e.g. butadiene, isoprene), among others.

Further, the amide group-containing acrylic resin particles may be either in crosslinked form or in uncrosslinked form. For crosslinking, a monomer or polymerizable compound having two or more radical-polymerizable ethylenically unsaturated groups per molecule may be used as monomers for preparing an aqueous dispersion of resin particles. Specifically, there may be mentioned polymerizable unsaturated monocarboxylic acid esters of polyhydric alcohols (e.g. ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol acroxydimethacrylate, 1,1,1-trishydroxymethylethane di(meth)acrylate, 1,1,1-trishydroxymethylethane tri(meth)acrylate, 1,1,1-trishydroxymethylpropane di(meth)acrylate), polymerizable unsaturated alcohol esters of polybasic acids (e.g. diallyl terephthalate, diallyl phthalate, triallyl trimellitate), aromatic compounds substituted by two or more vinyl groups (e.g. divinylbenzene), and adducts from an epoxy group-containing, ethylenically unsaturated monomer and a carboxyl group-containing, ethylenically unsaturated monomer (e.g. reaction products of glycidyl (meth)acrylate with acrylic acid, methacrylic acid, crotonic acid or maleic acid).

Such other ethylenically unsaturated monomers may be used singly or two or more of them may be used in admixture.

The emulsion polymerization is carried out by dissolving an emulsifier in water or, if necessary in an aqueous medium containing an organic solvent such as an alcohol, and adding dropwise the ethylenically unsaturated monomers and a polymerization initiator with heating and stirring. The ethylenically unsaturated monomers may also be added dropwise in the form of an emulsion prepared in advance using an emulsifier and water.

Suited for use as the polymerization initiator are lipophilic azo compounds (e.g. azobisisobutyronitrile, 2,2′-azobis(2-methylbutyronitrile), 2,2′-azobis(2,4-dimethylvaleronitrile)), and hydrophilic azo compounds (e.g. 4,4′-azobis(4-cyanovaleric acid) and 2,2′-azobis(2-methyl-propionamidine)); redox system lipophilic peroxides (e.g. benzoyl peroxide, p-chlorobenzoyl peroxide, lauroyl peroxide, tert-butyl perbenzoate) and redox system hydrophilic peroxides (e.g. potassium persulfate, ammonium persulfate).

The above emulsifier may be any of those generally used in the art. Particularly preferred, however, are reactive emulsifiers, for example Antox MS-60 (product of Nippon Nyukazai), RA-1022 (product of Nippon Nyukazai), Eleminol IS-2 (product of Sanyo Chemical Industries), Aronix M-5300 (product of Toa-Gosei Chemical Industry) and Aqualon HS-10 (product of Dai-Ichi Kogyo Seiyaku).

Further, if necessary for molecular weight adjustment, a chain transfer agent, such as a mercaptan (e.g. lauryl mercaptan) and α-methylstyrene dimer, may be used.

The reaction temperature is determined by the initiator. With an azo type initiator, for instance, it is generally 60 to 90° C. and, in a redox system, it is generally 30 to 70° C. The reaction time is generally 1 to 8 hours. The amount of the initiator is generally 0.1 to 5% by weight, preferably 0.5 to 2% by weight, based on the total amount of unsaturated compounds.

The particle diameter of the amide group-containing acrylic resin particles is preferably within the range of 0.01 to 1.0 μm. When the particle diameter is smaller than 0.01 μm, the workability-improving effect will be little. When it is in excess of 1.0 μm, the coating films obtained may be inferior in appearance. The particle diameter can be adjusted by a method well known in the art, for example by modifying the monomer composition.

The aqueous dispersion of amide group-containing acrylic resin particles can be used after neutralization to pH 5 to 10 with a base. This is because the aqueous dispersion is highly stable in this pH range. This neutralization is preferably made by adding a tertiary amine, such as dimethylethanolamine and triethylamine, to the system before or after polymerization.

The film-forming resin, which is a component of the water-based intermediate coating to be used in the coating film forming method of the invention, is not particularly restricted. Thus, such film-forming resins as acrylic resins, polyester resins, alkyd resins, epoxy resins and urethane resins can be utilized, and these are used in combination with a curing agent such as an amino resin, a blocked isocyanate resin, a metal ion, an epoxy compound, an aziridine compound, a carbodiimide compound and oxazoline compound. Considering the performance characteristics and cost of the coating films obtained, the use of an amino resin and/or a blocked isocyanate resin is generally preferred.

The mixing ratio between the aqueous dispersion of amide group-containing acrylic resin particles and the film-forming resin among the above resin components is such that the aqueous dispersion of amide group-containing acrylic resin particles accounts for 5 to 90% by weight, preferably 5 to 60% by weight, and the film-forming resin for 95 to 10% by weight, preferably 95 to 40% by weight, based on the sum total thereof. When the aqueous dispersion of amide group-containing acrylic resin particles accounts for less than 5% by weight, sufficient sagging inhibition will not be attained, hence the appearance will become poor. When it is above 90% by weight, the film forming ability will be low.

The amino resin as the curing agent is not particularly restricted but may be a water-soluble melamine resin or a water-insoluble melamine resin. For example, there may be mentioned “Cymel 303”, “Cymel 254” and “U-Van 20N60” available from Mitsui Toatsu Chemicals and “Sumimal M50W” available from Sumitomo Chemical Industries.

The amino resin is used preferably in an amount of 20 to 100% by weight relative to the aqueous dispersion of amide group-containing acrylic resin particles and the coating film-forming resin on the solid matter basis. When it is used in an amount smaller than 20% by weight, the curability will be insufficient. When it is above 100% by weight, the cured film will be excessively hard, hence brittle.

Further, as the blocked isocyanate resin, there may be mentioned those which are obtained by adding a blocking agent to a polyisocyanate and from which isocyanato groups are generated by dissociation of the blocking agent upon heating and react with the functional group in the acrylic resin to thereby cure the acrylic resin.

The above blocked isocyanate resin is not particularly restricted. As typical polyisocyanates which can be used, there may be mentioned aliphatic isocyanates such as trimethylene diisocyanate, tetramethylene diisocyanate, pentamethylene diisocyanate, hexamethylene diisocyanate and trimethylhexamethylene diisocyanate, aliphatic cyclic isocyanates such as 1,3-cyclopentanediisocyanate, 1,4-cyclohexanediisocyanate and 1,2-cyclohexanediisocyanate, aromatic isocyanates such as xylylene diisocyanate, 2,4-tolylene diisocyanate and 2,6-tolylene diisocyanate, alicyclic isocyanates such as isophoronediisocyanate and norbornanediisocyanate methyl, nurate derivatives of these, and mixtures thereof.

As the blocking agent, there may be mentioned, for example, halogenated hydrocarbons, aliphatic, aromatic or heterocyclic alcohols such as methanol, ethanol, n-propanol, isopropanol, furfuryl alcohol, alkyl-substituted furfuryl alcohols and benzyl alcohol, phenols, oximes such as methyl ethyl ketone oxime, methyl isobutyl ketone oxime, acetone oxime and cyclohexanone oxime, active methylene compounds such as acetylacetone, ethyl acetoacetate and ethyl malonate and, further, caprolactam and the like.

Among them, oximes are preferred and, among alcohols, furfuryl alcohol and alkyl-substituted furfuryl alcohols are preferred. Further, a catalyst may be used for dissociating the blocking agent.

The blocked isocyanate is used in an amount of 20 to 100 parts by weight per 100 parts by weight of the resin solids in the coating. Outside the above range, insufficient curing will result.

The color pigment to be contained in the above intermediate coating includes, among others, organic pigments such as azo chelate pigments, insoluble azo pigments, condensed azo pigments, phthalocyanine pigments, indigo pigments, perinone pigments, perylene pigments, dioxane pigments, quinacridone pigments, isoindolinone pigments and metal complex pigments, and inorganic pigments such as chrome yellow pigments, iron oxide yellow, iron oxide red, carbon black and titanium dioxide. Usable as the extender pigment are calcium carbonate, barium sulfate, clay, talc and the like. Further, flat pigments such as aluminum powder and mica may also be added.

Normally, gray-colored intermediate coatings containing carbon black and titanium dioxide as main pigments are used. Further, set gray intermediate coatings harmonized in hue with top coatings or the so-called color intermediate coatings containing various color pigments in combination may also be used.

A further viscosity modifier may also be added to the above intermediate coating to prevent draping with respect to the top coating film and/or provide for coating workability. Generally usable as the viscosity modifier are agents showing thixotropy, and there may be mentioned, for example polyamide-based ones such as swollen dispersions of fatty acid amide, amidated fatty acids and long-chain polyaminoamide phosphate salts, polyethylene-based ones such as colloid-like swollen dispersions of polyethylene oxide, organic bentonite-based ones such as organic acid-smectite clay and montmorillonite, inorganic pigments such as aluminum silicate and barium sulfate, and flat pigments capable of modifying the viscosity owing to their shape.

In the water-based intermediate coating to be used according to the invention, there may be incorporated, in addition to the above ingredients, other additives generally used in coatings, for example surface modifiers, antioxidants and antifoaming agents. The addition amount thereof are within the ranges known to those skilled in the art.

The method of preparing the coatings to be used in the practice of the invention, inclusive of those mentioned later herein, is not particularly restricted but any of the method known in the art can be used, for example the method comprising kneading and blending a composition containing a pigment(s) and other ingredients using a kneader, a roll mill or the like.

Metallic Coating Film

In the method of forming a coating film according to the invention, the metallic coating film is comprised of a metallic base coating film formed from a water-based metallic base coating and a clear coating film. The water-based metallic base coating for forming the above metallic base coating film contains a film-forming resin, a curing agent, a color pigment, a luster color pigment and so on.

The film-forming resin is not particularly restricted. As preferred species, however, there may be mentioned resins prepared by solubilizing, using a base, an amide group-containing acrylic resin obtained by solution polymerization of a monomer composition comprising 5 to 40% by weight, preferably 8 to 30% by weight, of an amide group-containing, ethylenically unsaturated monomer, 3 to 15% by weight, preferably 5 to 13% by weight, of an acidic group-containing, ethylenically unsaturated monomer, 10 to 40% by weight, preferably 13 to 30% by weight, of a hydroxyl group-containing, ethylenically unsaturated monomer and the rest of another ethylenically unsaturated monomer or monomers.

The amount of the amide group-containing, ethylenically unsaturated monomer is less than 5% by weight, the orientation of scale-like metal pigments becomes insufficient, hence the coating film obtained will become worse in appearance. When it exceeds 40% by weight, the water resistance of the resulting coating film will become low. When the amount of the acidic group-containing, ethylenically unsaturated monomer is below 3% by weight, the water dispersibility of the coating film-forming polymer will be reduced. When it is above 15% by weight, the water resistance of the resulting coating film will become poor. When the hydroxyl group-containing, ethylenically unsaturated monomer is less than 10% by weight, the curability of the coating film will be insufficient. When it is in excess of 40% by weight, the water resistance of the resulting coating film will be insufficient.

The thus-obtained amide group-containing acrylic resin has a number average molecular weight of 6,000 to 50,000, preferably 8,000 to 30,000. When it is lower than 6,000, the workability and curability will be insufficient. When it exceeds 50,000, the solid matter content in the step of application becomes too low, rather worsening the workability. The “molecular weight” so referred to herein is determined by the GPC (gel permeation chromatography) method using styrene polymers as standards.

The amide group-containing acrylic resin preferably has an acid value of 10 to 100 mg KOH/g, more preferably 20 to 80 mg KOH/g. When the upper limit is surpassed, the water resistance of the resulting coating film decreases and, at an acid value below the lower limit, the water dispersibility of the resin decreases. Also preferably, the resin has a hydroxyl value of 20 to 180 mg KOH/g, more preferably 30 to 160 mg KOH/g. When the upper limit is surpassed, the water resistance of the resulting coating film decreases and, at below the lower limit, the curability of the coating film decreases.

As the amide group-containing, ethylenically unsaturated monomer to be used in preparing the above amide group-containing acrylic resin, there may be mentioned those species mentioned above referring to the production of the aqueous dispersion of amide group-containing resin particles. Preferred are acrylamide and methacrylamide.

The acidic group of the above-mentioned acidic group-containing, ethylenically unsaturated monomer may be a carboxyl group or a sulfo group. As examples of the carboxyl group-containing, ethylenically unsaturated monomer, there may be mentioned styrene derivatives (e.g. 3-vinylsalicylic acid, 3-vinylacetylsalicylic acid); (meth)acrylic acid derivatives (e.g. acrylic acid, methacrylic acid, crotonic acid, isocrotonic acid, acrylic acid dimer, acrylic acid-ε-caprolactone adduct, namely α-hydro-ω-[(1-oxo-2-propenyl)oxy]poly[oxy(1-oxo-1,6-hexanediyl)]); and unsaturated dibasic acids (e.g. maleic acid, fumaric acid, itaconic acid), half esters, half amides and half thioesters thereof. Preferred species of the carboxyl group-containing, ethylenically unsaturated monomer are the above-mentioned styrene derivatives, (meth)acrylic acid derivatives and unsaturated dibasic acid. Preferred are (meth)acrylic acid derivatives; more preferred are acrylic acid, methacrylic acid, acrylic acid dimer and α-hydro-ω-[(1-oxo-2-propenyl)oxy]poly[oxy(1-oxo-1,6-hexanediyl)].

As examples of the sulfo-containing, ethylenically unsaturated monomer, there may be mentioned p-vinylbenzenesulfonic acid and 2-acrylamidopropanesulfonic acid, among others.

As specific examples of the above-mentioned hydroxyl group-containing, ethylenically unsaturated monomer, there may be mentioned 2-hydroxyethyl (meth)acrylate, 2-hydroxypropyl (meth)acrylate, hydroxybutyl (meth)acrylate, allyl alcohol, methacryl alcohol, 2-hydroxyethyl (meth) acrylate-ε-caprolactone adduct, 2,4-dihydroxy-4′-vinylbenzophenone, N-(2-hydroxyethyl) acrylamide and N-(2-hydroxyethyl)methacrylamide, among others.

The other ethylenically unsaturated monomers are ethylenically unsaturated monomers which will not adversely affect the polymerization and are inactive to the acidic group and hydroxyl group, among others. As typical species, there may be mentioned those other ethylenically unsaturated monomers mentioned hereinabove referring to the production of the aqueous dispersion of amide group-containing acrylic resin particles.

The amide group-containing acrylic resin can be obtained by radical-copolymerizing the above ethylenically unsaturated monomers. The method of polymerization may be any of those conventional ones which are known and described in the literature, for example solution radical polymerization. Thus, for example, there can be mentioned the method comprising adding a radical polymerization initiator and a monomer mixture solution dropwise to an appropriate solvent with stirring over 2 to 10 hours at a polymerization temperature of 60 to 160° C. The radical polymerization initiator to be used here is not particularly restricted but may be any of those generally used for polymerization purposes. For instance, azo compounds and peroxides may be mentioned. The solvent to be used here is not particularly restricted, either, but may be any of those which will not adversely affect the reaction. For instance, mention may be made of alcohols, ketones and hydrocarbon solvents, among others. Furthermore, a chain transfer agent, for example a mercaptan such as lauryl mercaptan or a-methylstyrene dimer, may be used when necessary.

The amide group-containing acrylic resin is preferably used at pH 5 to 10 after neutralization with a base. This is because the resin is highly stable in that pH range. More preferably, the neutralization is effected by adding a tertiary amine, such as dimethylethanolamine and triethylamine, before or after polymerization.

Furthermore, in addition to the amide group-containing acrylic resin, another acrylic resin, a polyester resin, an alkyd resin, an epoxy resin, a urethane resin and/or the like may be used combinedly as a film-forming resin.

It is still more preferred to incorporate that aqueous dispersion of amide group-containing acrylic resin particles as mentioned hereinabove referring to the film-forming resin for use in the intermediate coating. By incorporating such aqueous dispersion of amide group-containing acrylic resin particles in the water-based metallic base coating, it is possible to control the imbibing and/or inversion at the interface between the coating films on the occasion of the water-based intermediate coating and water-based metallic base coating being applied in that order.

The mixing ratio between the aqueous dispersion of amide group-containing acrylic resin particles and the above film-forming resin is selected so that the aqueous dispersion of amide group-containing acrylic resin particles may account for 5 to 90% by weight, preferably 5 to 60% by weight, and the film-forming resin for 95 to 10% by weight, preferably 95 to 40% by weight, based on the sum total thereof. When the aqueous dispersion of amide group-containing acrylic resin particles accounts for less than 5% by weight, the sagging-preventing and appearance improving effects will become insufficient and, when it accounts for more than 90% by weight, the film-forming ability will become poor.

The above film-forming resin may be used in combination with such a curing agent as mentioned hereinabove referring to the intermediate coating. From the finished coating film performance and cost viewpoint, an amino resin and/or a blocked isocyanate is generally used as the curing agent.

As the color pigment, there may be mentioned those mentioned hereinabove referring to the intermediate coating. Further, a viscosity modifier is preferably added to the metallic base coating for securing the workability in coating, as for the intermediate coating mentioned above. The viscosity modifier is used for the purpose of forming good coating films showing no mottling or sagging and agents showing thixotropy can generally be used. As such, there may be mentioned those described hereinabove referring to the intermediate coating.

The total solid content of the metallic base coating to be used in the practice of the invention is 15 to 50% by weight, preferably 18 to 45% by weight. Outside the upper and lower limits, the stability of the coating will be decreased. When the upper limit is exceeded, the viscosity will become excessively high and the coating film will become poor in appearance. At a content below the lower limit, the viscosity will be excessively low, hence appearance defects such as imbibing and coating mottling may appear.

The luster color pigment to be contained in the above metallic base coating is not particularly restricted in shape. It may be colored. Preferably, however, it has an average particle diameter (D₅₀) of 2 to 50 μm and a thickness of 0.1 to 5 μm. More suitably, the average particle diameter is within the range of 10 to 35 μm since better glittering effects can then be obtained.

The pigment weight concentration (PWC) of the luster color pigment in the above coating is generally not more than 18.0%. When the upper limit is exceeded, the coating film appearance will be worsened. A preferred PWC is 0.01% to 15.0%, more preferably 0.01% to 13.0%.

As the luster color pigment, there may be mentioned uncolored or colored metal luster pigments, for example metals or alloys such as aluminum, copper, zinc, iron, nickel, tin, aluminum oxide, and mixtures thereof. Further, interfering mica pigments, white mica pigments, graphite pigments and other colored or uncolored flat pigments may be used combinedly.

The total pigment weight concentration (PWC), inclusive of the luster color pigment and all other pigments, in the coating is 0.1 to 50% by weight, preferably 0.5% to 40%, more preferably 1.0% to 30%. At a PWC exceeding the upper limit, the coating film appearance will become poor.

A urethane-containing aqueous dispersion may be added to the water-based metallic base coating to be used in the practice of the invention to thereby improve the water resistance and/or chipping resistance. As an example, there may be mentioned a dispersion prepared by dispersing a hydrophilic group-containing oligomer, which is obtained by reacting a hydroxyl-terminated diol having a molecular weight of 100 to 5,000 and a compound having at least one active hydrogen atom and a hydrophilic group within the molecule with a diisocyanate under isocyanate excess conditions, in an aqueous medium containing a primary and/or secondary polyamine, as disclosed in Japanese Kokai Publication Hei-04-25582. The amount of the urethane-containing aqueous dispersion is preferably 5 to 90% by weight based on 100 parts by weight (of solid matter) of the water-based metallic base coating. At an addition amount below 5% by weight, the effects of the addition will be poor and, at amounts exceeding 90% by weight, the curability may be adversely affected.

The water-based metallic base coating to be used in the practice of the invention may further contain a phosphoric acid ester having a long-chain alkyl group containing 8 to 18 carbon atoms and having an HLB of 3 to 12 for the purpose of improving the wettability with the undercoating film and improving the adhesion.

The above alkyl group preferably contains 8 to 18 carbon atoms. When the number of carbon atoms is less than 8, a decrease in wettability to undercoating film is observed this leads to decrease in adhesion. When the number of carbon atoms exceeds 18, the compound may precipitate out in the coating, causing troubles. More preferably, the number of carbon atoms is 10 to 14 and, at that time, the wettability becomes better and the adhesion is improved. The above compound has an HLB of 3 to 12, preferably 4 to 8. The HLB value can be calculated from Griffin's formula: HLB=20×(MH/M) [where MH is the molecular weight of the hydrophilic portion and M is the molecular weight of the active agent] based on the weight fraction. The molecular weight of the hydrophilic portion as used is the molecular weight of a phosphoric acid ester, sulfonic acid or carboxylic acid. Outside the above range, it is not preferred because of decrease in the wettability.

As preferred compounds, there may be mentioned 2-ethylhexyl acid phosphate, mono- or diisodecyl acid phosphate, mono- or ditridecyl acid phosphate, mono- or dilauryl acid phosphate, mono- or bis(nonylphenyl) acid phosphate and the like.

The addition amount of the above ingredient is preferably 0.1 to 5% by weight, more preferably 0.5 to 2% by weight, based on the total amount of the resin solids. At an amount below the lower limit, the adhesion decreases. Conversely, at an amount exceeding the upper limit, the water resistance decreases.

The water-based metallic base coating may incorporate, in addition to the components mentioned above, additives generally used in coatings, for example, surface modifiers, thickening agents, antioxidants, ultraviolet absorbers, antifoaming agents and the like. The addition amount thereof are as known in the art.

Clear Coating

The clear coating for forming the clear coating film is not particularly restricted but may be a clear coating comprising a heat-curable film-forming resin and a curing agent. As for the forms of the clear coating which are adequate for use, there may be mentioned solvent-base, water-based and powder-form clear coatings.

As preferred examples of the above solvent-base clear coating, there may be mentioned, from the transparency or acid etching resistance viewpoint, the combination of an acrylic resin and/or a polyester resin and an amino resin, and an acrylic resin and/or a polyester resin with a carboxylic acid-epoxy curing system, and the like.

Further, the above clear coating preferably contains a viscosity modifier for securing the workability in application, like the intermediate coating mentioned above. Agents showing thixotropy can be generally used as the viscosity modifier. As such, there may be mentioned those mentioned hereinabove referring to the intermediate coating. If necessary, it may further contain a curing catalyst, a surface modifier, etc.

As an example of the water-based clear coating, there may be mentioned one containing a resin derived from the film-forming resin mentioned above for use in the above solvent-base clear coating by neutralization with a base for rendering the resin dispersible in water. The neutralization can be effected by adding a tertiary amine such as dimethylethanolamine and triethylamine before or after polymerization.

As for the powder-form clear coating, ordinary powder coating forms such as thermoplastic and thermosetting powder coatings can be used. Among them, thermosetting powder coatings are preferred since they give coating films having good physical properties. As specific thermosetting powder coatings, there may be mentioned epoxy, acrylic and polyester-based powder clear coatings. Acrylic powder clear coatings are particularly preferred since they can provide good weather resistance.

Such an acrylic powder clear coating comprises a main component, generally comprising a functional acrylic resin, and a curing agent therefor. The functional acrylic resin is prepared by copolymerizing a functional group-containing, ethylenically unsaturated monomer with another copolymerizable monomer or monomers. These monomers are not particularly restricted but includes those well known to those skilled in the art. For example, functional acrylic resins can be prepared by techniques well known in the art using a functional group-containing, ethylenically unsaturated monomer, such as glycidyl (meth)acrylate, methylglycidyl (meth)acrylate, hydroxyethyl (meth)acrylate, hydroxybutyl (meth)acrylate, acrylic acid and methacrylic acid, and another ethylenically unsaturated monomer or monomers.

The curing agent is not particularly restricted but may be any of those known in the art to react with the functional group of the above-mentioned functional acrylic resin to thereby cause the curing to proceed. For example, polybasic carboxylic acids, phenols, amines, blocked isocyanates, uretodione group-containing blocked isocyanates, alkoxyalkylglycol uryl epoxy compounds, hydroxyalkylamide compounds and the like can be used according to the functional group of the functional acrylic resin. If necessary, a curing catalyst, a surface modifier and/or the like may be used.

A powder coating based on the epoxy-containing acrylic resin/polycarboxylic acid system is particularly preferred as the powder-form clear coating to be used in the practice of the invention since it produces no volatile matter in the step of curing, gives good appearance and causes little yellowing.

The film thickness of the above-mentioned clear coating may vary according to the intended use but, in many cases, a thickness of 10 to 80 μm is of practical use. Beyond the upper limit, the sharpness may decrease or troubles, such as mottling, pinholes and runs, may arise in the step of application. Below the lower limit, the undercoating film may not be masked thoroughly but remain locally uncovered.

Substrate

The film forming method of the invention can be applied with advantage to various substrates, for example metals, plastics, foamed articles and so forth, in particular metal surfaces, and castings. It is particularly preferred to apply it to metal products capable of undergoing cationic electrodeposition coating.

As the metal products, there may be mentioned, for example, metals such as iron, copper, aluminum, tin and zinc, and alloys containing these metals. Specifically, there may be mentioned bodies and parts of cars such as automobiles, trucks, motorcycles and buses. Particularly preferred among them are those metals that have been undergone chemical conversion treatment with a phosphate, a chromate or the like.

Electrodeposited Coating Film

The electrodeposition coating to be used in the metallic coating forming method of the invention for forming an electrodeposited coating film on chemically converted steel panels may be of cationic or anionic type. Cationic electrodeposition coatings are preferred, however, since they give multi-layer coating films excellent in corrosion resistance.

Coating Film Forming Method

According to the coating film forming method of the invention, after electrodeposited coating film formation, an intermediate coating film, a metallic base coating film and a clear coating film can be formed in that order on an uncured or cured electrodeposited coating film using the water-based intermediate coating, water-based metallic base coating and clear coating, respectively.

When the water-based intermediate coating is applied to car bodies according to the invention, such coating film forming techniques as multistage (preferably two-stage) coating by electrostatic air spray coating, and the coating technique combining electrostatic air spray coating and the use of a rotary atomizer type electrostatic coater commonly called “μμ (micromicro) bell”, “μ (micro) bell” or “Metabell” can be used for improving the quality of appearance.

In the practice of the invention, the film thickness in the step of application of the water-based intermediate coating may vary according to the intended use but, in many cases, a thickness of 10 to 60 μm is useful. Above the upper limit, the sharpness may be low or troubles such as mottling and runs may occur in the step of application. Below the lower limit, the undercoating film may not be masked thoroughly but remain locally uncovered.

According to the coating film forming method of the invention, a metallic base coating and a clear coating can further be formed on the uncured or preheated water-based intermediate coating film by applying the water-based metallic base coating and clear coating, respectively, on the wet-on-wet basis.

The water-based metallic base coating to be used for forming a metallic base coating according to the invention can be applied by electrostatic air spray coating or using a rotary atomizer type electrostatic coater such as a μμ bell or μ bell, just as said water-based intermediate coating. The dry film thickness of that coating film can be selected within the range of 10 to 30 μm.

According to the coating film forming method of the invention, the clear coating film, which is provided after formation of the above metallic base coating film, is formed for smoothening the uneceness, peppering or the like due to the luster color pigment contained in the metallic base coating film and for protecting that coating film. As for the method of application, the above-mentioned coating film forming method specifically using a rotary atomizer type electrostatic coater such as a μμ bell or μ bell is preferred.

The dry film thickness of the clear coating film formed by the above clear coating is in general preferably about 10 to 80 μm, more preferably about 20 to 60 μm. Above the upper limit, such troubles as popping and sagging may occur in the step of application. Below the lower amount, the unevenness of the undercoating film cannot be masked.

The coating films formed in the above manner may be cured one by one after each coating film formation. It is possible, however, to effect coating film formation by curing all the multi-layer coating films simultaneously, namely in the so-called three-coat one-bake manner. In that case, the curing and drying ovens can be omitted and this is preferable from the economical and environmental viewpoint. For obtaining better finished coating films, it is desirable that the coating films formed from the water-based intermediate coating and water-based metallic base coating, respectively, be each heated, after formation, at 40 to 100° C. for 2 to 10 minutes.

By selecting the curing temperature for curing the coating films after application of the clear coating within the range of 80 to 180° C., preferably 120 to 160° C., it is possible to obtain cured coating films with a high degree of crosslinking. Above the upper limit, the coating films become rigid and brittle and, below the lower limit, the curing will be insufficient. The curing time depends on the curing temperature. It is judicious, however, to carry out the curing at 120° C. to 160° C. for 10 to 30 minutes.

The multi-layer coating film formed according to the invention has a thickness of 30 to 300 μm in many instances, preferably 50 to 250 μm. Above the upper limit, the film properties such as resistance to thermal shock cycles may become deteriorated and, below the lower limit, the strength of the films themselves decreases.

According to the method of the invention, it is possible to provide high-appearance multi-layer coating films by sequential formation of a water-based intermediate coating and a metallic coating on a commercial scale while controlling the imbibing or inversion at each interface between the respective coating films.

### EXAMPLES

The following specific examples illustrate the present invention in detail. However, the following examples should not be construed as being limitative of the scope of the invention. In the following, “part(s)” means “part(s) by weight”.

### Production Examples

Production of Film-Forming Resin 1

A one-liter reaction vessel equipped with a nitrogen inlet tube, stirrer, temperature controller, dropping funnel and condenser was charged with 76 parts of ethylene glycol monobutyl ether. Separately, a monomer solution was prepared by mixing up 15 parts of styrene, 63 parts of methyl methacrylate, 48 parts of 2-hydroxyethyl methacrylate, 117 parts of n-butyl acrylate, 27 parts of methacrylic acid, 30 parts of acrylamide and 3 parts of azobisisobutyronitrile. A 61-part portion of this monomer solution was added to the reaction vessel and the temperature was raised to 120° C. with stirring. Then, 242 parts of the monomer solution was further added over 3 hours and then stirring was continued for 1 hour. An amide group-containing acrylic resin (1) was obtained which had a number average molecular weight of 12,000, a hydroxyl value of 70 mg KOH/g and an acid value of 58 mg KOH/g. Thereafter, 28-parts of diethanolamine and 200 parts of deionized water were added, to give a viscous, amide group-containing acrylic resin varnish ah. (1) with a solid matter content of 50%.

Production of Film-Forming Resin 2

A 3-liter reaction vessel equipped with a nitrogen inlet tube, stirrer, temperature controller, dropping funnel and decanter was charged with 500 parts of 2-ethoxypropanol, and the temperature was raised to 100° C. A monomer solution was prepared by charging into the dropping funnel 50 parts of styrene, 50 parts of methyl methacrylate, 200 parts of 2-hydroxyethyl methacrylate, 120 parts of 2-ethylhexyl methacrylate, 380 parts of n-butyl acrylate, 100 parts of maleic acid monobutyl ester dissolved in 300 parts of methanol, 100 parts of acrylamide and 30 parts of azobisisobutyronitrile (as polymerization initiator). This monomer solution was added dropwise over 3 hours while maintaining the reaction vessel inside at 100° C. and distilling off the methanol utilizing the decanter. After further 0.5 hour of stirring, an initiator solution composed of 50 parts of butyl acetate and 3 parts of tert-butylperoxy 2-ethylhexanoate was added dropwise over 30 minutes. After dropping, 100 parts of the methanol was further distilled off over 1.5 hours while maintaining the temperature at 100° C. Thereafter, 220 parts of the solvent was distilled off under reduced pressure. An amide group-containing acrylic resin (2) was obtained which had a number average molecular weight of 10,000, a hydroxyl value of 88 mg KOH/g and an acid value of 32 mg KOH/g. Further, 100 parts of diethanolamine and 570 parts of deionized water were added for effecting dissolution, to give a viscous, amide group-containing acrylic resin varnish (2) with a solid matter content of 50%. Production of film-forming resin 3 An acrylic resin (3) with a number average molecular weight of 11,000, a hydroxyl value of 70 mg KOH/g and an acid value of 58 mg KOH/g was obtained in the same manner as in Production Example 1 except that styrene was used in an amount of 45 parts and that the use of acrylamide was omitted. Further, a viscous acrylic resin varnish (3) with a solid matter content of 50% was obtained in the same manner as in Production Example 1.

Production of Aqueous Dispersion 1 of Amide Group-Containing Acrylic Resin Particles

A 500-ml reaction vessel equipped with a nitrogen inlet tube, stirrer, temperature controller and dropping funnel was charged with 165 parts of deionized water and the temperature was raised to 83° C. A mixture of Aronix M-5300 (reactive emulsifier, product of Toagosei Chemical Industry), 5.9 parts of dimethylethanolamine and 70 parts of styrene and a monomer solution prepared by dissolving 10 parts of acrylamide in 20 parts of deionized water were added dropwise over 2 hours. Further, an initiator solution prepared by neutralizing 1 part of 4,4″-azobis-4-cyanovaleric acid with 0.55 part of dimethylethanolamine and dissolving the neutralization product in 40 parts of deionized water was added dropwise simultaneously with the addition of the monomer solution. Further, stirring was continued at 83° C. for 1 hour and then the reaction mixture was cooled to give a milky white emulsion. The solid content of the aqueous dispersion was 30% and the particle diameter was 120 nm as determined by the laser scattering method.

Production of Aqueous Dispersion 2 of Amide Group-Containing Acrylic Resin Particles

A milky white emulsion was obtained in the same manner as in the production of aqueous dispersion 1 of amide group-containing acrylic resin particles except that styrene was used in an amount of 50 parts in the monomer solution and that 20 parts of ethylene glycol dimethacrylate was further added. The aqueous dispersion has a solid matter content of 30% and the particle size was 100 nm as determined by the laser scattering method.

Production of Aqueous Dispersion 3 of Amide Group-Containing Acrylic Resin Particles

The same reaction vessel as used in the production of aqueous dispersion 1 of amide group-containing acrylic resin particles was charged with 205 parts of deionized water and 5 parts of RA-1022 (reactive emulsifier, product of Nippon Nyukazai), and the temperature was raised to 83° C. A mixture of 20 parts of ethylene glycol dimethacrylate, 40 parts of styrene, 30 parts of n-butyl acrylate and 10 parts of RA-1022 and a monomer solution prepared by dissolving 10 parts of acrylamide in 20 parts of deionized water were added dropwise over 2 hours. Further, an initiator solution prepared by neutralizing 1 part of 4,4′-azobis-4-cyanovaleric acid with 0.55 part of dimethylethanolamine and dissolving the neutralization product in 40 parts of deionized water was added dropwise simultaneously with the addition of the monomer solution. Further, stirring was continued at 83° C. for 1 hour and then the reaction mixture was cooled to give a milky white emulsion. The solid content of the aqueous dispersion was 30% and the particle diameter was 130 nm as determined by the laser scattering method.

Production of an Aluminum Pigment Solution for use in Metallic Base Coating Preparation

“Cymel 303” (methoxylated methylolmelamine, product of Mitsui Cytec; 30 parts) was added to 15 parts of an aluminum pigment paste “Alpaste 7160N” (aluminum content 65%; product of Toyo Aluminium), followed by uniform blending. Further, 2 parts of “Phoslex A-180L” (isostearyl phosphate, product of Sakai Chemical Industry) was uniformly admixed with the above mixture, to give an aluminum pigment solution.

Production of a Urethane-Containing Aqueous Dispersion

(1) Production of a Urethane Prepolymer

A one-liter reaction vessel equipped with a nitrogen inlet tube, stirrer, condenser and temperature controller was charged with 40.2 parts of dimethylolpropionic acid, 30 parts of triethylamine and 312 parts of N-methylpyrrolidone and the mixture was heated to 90° C. for dissolution. Thereto were added 290 parts of isophoronediisocyanate and 700 parts of polypropylene glycol with a molecular weight of 1,000 and, after 10 minutes of stirring, 1.03 parts of dibutyltin laurate was added. Then, the temperature was raised to 95° C. and the reaction was allowed to proceed for 1 hour.

(2) Production of an Aqueous Dispersion

A 5-liter reaction vessel equipped with a nitrogen inlet tube, stirrer, condenser, temperature controller and dropping funnel was charged with 1,757 parts of deionized water and 9,2 parts of hydrazine hydrate and, with stirring, the urethane prepolymer solution obtained as described above under (1). Then, stirring was continued for 30 minutes. The composition obtained occurred as a white turbid stable aqueous dispersion. The solid matter had an acid value of 16.2 mg KOH/g and the solid matter content was 33%.

Production of Solvent-Base Clear Coating 1

(1) Varnish Production

A reaction vessel equipped with a nitrogen inlet tube, stirrer, temperature controller, dropping funnel and condenser was charged with 70 parts of xylene and 20 parts of n-butanol. Separately, a monomer solution was prepared by mixing up 1.2 parts of methacrylic acid, 26.4 parts of styrene, 26.4 parts of methyl methacrylate, 10.0 parts of 2-hydroxyethyl methacrylate, 36.0 parts of n-butyl acrylate and 1.0 part of azobisisobutyronitrile. A 20-part portion of this monomer solution was added to the reaction vessel and the temperature was raised with stirring. The remaining 81 parts of the monomer solution was added dropwise over 2 hours under refluxing and then an initiator solution composed of 0.3 part of azobisisobutyronitrile and 10 parts of xylene was added dropwise over 30 minutes. The reaction mixture was further refluxed with stirring for 2 hours and then the reaction was finished, to give an acrylic resin varnish with a solid matter content of 50%. The resin had a number average molecular weight of 8,000, an acid value of 8 mg KOH/g and a hydroxyl value of 48 mg KOH/g.

(2) Polyester Resin Production

A 2-liter reaction vessel equipped with a nitrogen inlet tube, stirrer, temperature controller, condenser and decanter was charged with 134 parts of bishydroxyethyltaurine, 130 parts of neopentyl glycol, 236 parts of azelaic acid, 186 parts of phthalic anhydride and 27 parts of xylene, and the temperature was raised. The reaction byproduct water was removed by azeotropic distillation with xylene. The temperature was raised to 190° C. over about 2 hours following the start of refluxing and the stirring and dehydration were continued until the carboxylic acid-due acid value reached 145. The reaction mixture was then cooled to 140° C. While maintaining the temperature at 140° C., 314 parts of Cardura E10 (glycidyl versatate, product of Shell) was added dropwise over 30 minutes and the reaction was then allowed to proceed for 2 hours with stirring and the reaction was thus terminated. The polyester resin obtained had a number average molecular weight of 1,054, an acid value of 59 mg KOH/g and a hydroxyl value of 90 mg KOH/g.

(3) Resin Particle Production

A one-liter reaction vessel equipped with a nitrogen inlet tube, stirrer, condenser and temperature controller was charged with 282 parts of deionized water, 10 parts of the polyester produced as mentioned above under (2) and 0.75 part of diethanolamine, and the mixture was stirred to effect dissolution while maintaining the temperature at 8° C. Thereto was added an initiator solution prepared by dissolving 45 parts of azobiscyanovaleric acid in 45 parts of deionized water plus 4.3 parts of dimethylethanolamine. Then, a monomer solution composed of 70.7 parts of styrene, 70.7 parts of methyl methacrylate, 94.2 parts of n-butyl acrylate, 30 parts of 2-hydroxyethyl acrylate and 4.5 parts of ethylene glycol dimethacrylate was added dropwise to the reaction vessel over 1 hour. After dropping, an initiator solution prepared by dissolving 1.5 parts of azobiscyanovaleric acid in 15 parts of deionized water plus 1.4 parts of dimethylethanolamine was added and the whole mixture was stirred at 80° C. for 1 hour. As a result, an emulsion was obtained with a solid matter content of 45%, a pH of 7.2, a viscosity of 92 cps (25° C.) and a particle diameter of 0.156 μm. This emulsion was spray-dried for removing water, and a dispersion in xylene was prepared by adding 200 parts of xylene to 100 parts of the resin particles obtained to thereby effect redispersion. The particle size was 0.3 μm.

(4) Production of Solvent-Base Clear Coating 1

The varnish (100 parts) produced as described above under (1), 38 parts of “U-Van 20SE-60” (butylated melamine resin, product of Mitsui Toatsu), 0.5 part of “Modaflow” (surface modifier, product of Monsanto) and 2.2 parts of the resin particles produced as mentioned above under (3) were placed in a stainless steel vessel and stirred using a stirrer for experimental use, to give a solvent-base clear coating (1).

Production of Solvent-Base Clear Coating 2

(1) Varnish Production

A 2-liter reaction vessel equipped with a nitrogen inlet tube, stirrer, temperature controller, dropping funnel and condenser was charged with 500 parts of butyl acetate, and the temperature was raised to 125° C. A monomer solution was prepared by charging into the dropping funnel 50 parts of styrene, 400 parts of glycidyl methacrylate, 350 parts of 2-hydroxyethyl methacrylate, 200 parts of 2-ethylhexyl acrylate and 70 parts of tert-butylperoxy 2-ethylhexanoate. This monomer solution was added dropwise to the reaction vessel over 3 hours. After completion of the dropping, the mixture was maintained at 125° C. for 30 minutes and then an initiator solution composed of 10 parts of tert-butylperoxy 2-ethylhexanoate and 250 parts of xylene was added dropwise over 30 minutes. After completion of the dropping, the reaction was further allowed to proceed at 125° C. for 2 hours, to give an acrylic resin varnish with a solid matter content of 59%. The resin had a number average molecular weight of 4,000, an epoxy equivalent of 360 and a hydroxyl value of 150 mg KOH/g.

(2) Production of a Carboxylic Acid Anhydride Group-Containing Polymer

A one-liter reaction vessel equipped with a nitrogen inlet tube, stirrer, temperature controller, dropping funnel and condenser was charged with 80 parts of xylene, and the temperature was raised to 115° C. A monomer solution composed of 25 parts of styrene, 21 parts of n-butyl acrylate, 95 parts of n-butyl methacrylate, 34 parts of 2-ethylhexyl methacrylate, 50 parts of itaconic anhydride, 100 parts of propylene glycol monomethyl ether acetate and 10 parts of tert-butylperoxy 2-ethylhexanoate was added dropwise to the reaction vessel over 3 hours and then stirring was continued for further 2 hours. As a result, a carboxylic acid anhydride group-containing polymer was obtained with a solid matter content of 53%. The resin has a number average molecular weight of 5,500.

(3) Production of a Half-Esterified Polymer

To 385 parts of the carboxylic acid anhydride group-containing polymer synthesized as described above under (2) were added 1.35 parts of triethylamine dissolved in 35 parts of butyl acetate as well as 18.2 parts of methanol, and the reaction was allowed to proceed at 40° C. for 12 hours. Complete disappearance of the acid anhydride group-due absorption (1785 cm⁻¹) was confirmed by IR spectrometry. Thus was obtained a half-esterified polymer.

(4) Production of Solvent-Base Clear Coating 2

The varnish (100 parts) produced as described above under (1), 133 parts of the half-esterified polymer produced as described above under (3), 0.3 part of tetrabutylammonium bromide, 1.2 parts of Tinuvin 900 (benzotriazole ultraviolet absorber, product of Ciba-Geigy) and 0.6 part of Sanol LS-292 (hindered amine light stabilizer, product of Sankyo) were placed in a stainless steel vessel and stirred using a stirrer for experimental use, to give a solvent-base clear coating (2). This was diluted to a viscosity suited for application with a thinner composed of butyl acetate and xylene (1/1).

Production of a Water-Based Clear Coating

(1) Production of a Water-Soluble Resin Varnish

A one-liter reaction vessel equipped with a nitrogen inlet tube, stirrer, temperature controller, dropping funnel and condenser was charged with 76 parts of ethylene glycol monobutyl ether and, further 61 parts of a monomer solution composed of 45 parts of styrene, 63 parts of methyl methacrylate, 48 parts of 2-hydroxyethyl methacrylate, 117 parts of n-butyl acrylate, 27 parts of methacrylic acid, 3 parts of lauryl mercaptan and 3 parts of azobisisobutyronitrile was added and the temperature was raised to 120° C. with stirring. Then, 242 parts of the above monomer solution was added dropwise over 3 hours, followed by 1 hour of continued stirring. An acrylic resin with a number average molecular weight of 6,000 and an acid value of 60 mg KOH/g was obtained. Further addition of 28 parts of dimethylethanolamine and 200 parts of deionized water gave an acrylic resin varnish with a solid matter content of 50%.

(2) Preparation of a Water-Based Clear Coating

A stainless steel vessel was charged with 70 parts of the acrylic resin varnish produced as described above under (1), 15 parts of Cymel 303 and 58 parts of deionized water, followed by stirring using a stirrer for experimental use, to give a water-based clear coating.

Production of a Powder-Form Clear Coating

(1) Acrylic Resin Production

A 2-liter reaction vessel equipped with a nitrogen inlet tube, stirrer, temperature controller, dropping funnel and condenser was charged with 630 parts of xylene, and the temperature was raised to 130° C. Then, the dropping funnel was charged with 200 parts of styrene, 270 parts of methyl methacrylate, 450 parts of glycidyl methacrylate, 80 parts of isobutyl methacrylate and 75 parts of tert-butylperoxy 2-ethylhexanoate, and the resulting monomer solution was added dropwise for 3 hours at a constant rate.

After completion of the dropping, the temperature was maintained with stirring for 30 minutes, during which an initiator solution composed of 70 parts of xylene and 1 part of tert-butylperoxy 2-ethylhexanoate was added dropwise at a constant rate using the dropping funnel. After completion of the dropping, the temperature was maintained with stirring for 1 hour. The xylene was distilled off under reduced pressure to give an acrylic resin in solid form. The number average molecular weight was 3,500 and the epoxy equivalent was 316.

(2) Production of a Powder-Form Clear Coating

The acrylic resin (70 parts) obtained as described above under (1), 19.1 parts of decanedicarboxylic acid, 0.11 part of CF-1056 (methylphenylsilicone, product of Toray Dow Silicone) and 0.89 part of benzoin were dry-mixed in a henschel mixer (product of Mitsui Miike Seisakusho) and the mixture was melt-dispersed in Co-kneader PR-46 (product of Buss) at a temperature of 100° C., then cooled, ground using a hammer mill and classified to give an epoxy-containing acrylic powder coating through a 150-mesh metal sieve to give an epoxy-containing acrylic powder coating.

### Example 1

Water-Based Intermediate Coating 1

The amide group-containing acrylic resin varnish 1 (76 parts) obtained as described above for the production of film-forming resin, 190 parts of rutile-form titanium oxide and 76 parts of deionized water were placed in a 1000-mL stainless steel vessel and mixed up for effecting dispersion at room temperature for 45 minutes using a paint conditioner, to give a white pigment paste.

To the above paste were added 95 parts of the above amide group-containing acrylic resin varnish 1, 285 parts of the aqueous dispersion obtained as described for the production of aqueous dispersion 3 of amide group-containing acrylic resin particles and 57 parts of Cymel 303, and the whole was stirred and mixed up for 30 minutes using a laboratory mixer to give a white intermediate coating (1).

Water-Based Metallic Base Coating 1

To 112 parts of the amide group-containing acrylic resin varnish 1 obtained as described hereinabove for the production of film-forming resin 1 was added 47 parts of the aluminum pigment solution obtained in the above production example. After attaining uniform dispersion, 47 parts of the aqueous dispersion obtained as described above for the production of aqueous dispersion 3 of amide group-containing acrylic resin particles was added and the whole was stirred for uniform dispersion to give a water-based metallic base coating (1).

Coating Film Forming

Steel panels were treated with zinc phosphate and coated with “PowerTop U-50” (cationic electrodeposition coating, product of Nippon Paint) to a dry film thickness of 20 μm by electrodeposition, followed by 30 minutes of curing at 160° C. The thus-prepared sheets were subjected to two-stage coating with a dilution of the water-based intermediate coating 1 produced in the above production example as prepared by dilution with deionized water to a viscosity of 40 seconds (determined at 20° C. using a No. 4 Ford cup) to a dry film thickness of 35 μm by the air spray technique. Between the two applications, there was placed one minute of interval setting. After the second application, setting was effected by putting an interval of 5 minutes.

Then, a dilution of the water-based metallic coating 1 produced in the above production example as prepared by dilution with deionized water to a viscosity of 30 seconds (determined at 20° C. using a No. 4 Ford cup) to a dry film thickness of 20 μm in two stages by the air spray technique. Between the two applications, there was placed one minute of interval setting. After the second application, setting was effected by putting an interval of 5 minutes, which was followed by 5 minutes of preheating at 80° C.

After preheating, the coated panels were allowed to cool to room temperature and coated with the solvent-base clear coating 1 prepared in the above production example to a dry film thickness of 40 μm in one stage, followed by 7 minutes of setting. Then, the coated panels were cured in a drier at 140° C. for 30 minutes.

The coated panels obtained were evaluated for appearance by the eye according to the following criteria.

Evaluation Criteria

∘: No appearance of imbibing

Δ: Slight appearance of imbibing

×: Appearance of imbibing

They were also evaluated for minute surface irregularities (surface roughness) by determining short wave values using a Wave Scan (product of BYK) according to the following criteria. The short wave value was 11.2.

Evaluation Criteria

∘: Short wave value not more than 20

Δ: Short wave value of 21 to 30

×: Short wave value not less than 31

The coated sheets obtained were further evaluated for sharpness using a tension meter according to the following criteria. The value obtained was 17.

Evaluation Criteria

∘: Not less than 16

Δ: 13 to 15

×: Not more than 12

The results of the above evaluations are shown in Table 1.

### Examples 2 to 5

Multi-layer coating films were produced in the same manner as in Example 1 using the respective combinations of the water-based intermediate coating, water-based metallic base coating and clear coating prepared by compounding the coating components specified in Table 1 except that the powder-form clear coating was applied to a dry film thickness of 80 μm and cured at 150° C. for 30 minutes. The coating films produced were evaluated in the same manner.

### Comparative Example 1

Multi-layer coating films were produced in the same manner as in Example 1 using the combination of the water-based intermediate coating, water-based metallic base coating and clear coating prepared by compounding the coating components specified in Table 1 except that the water-based intermediate coating was prepared without using the aqueous dispersion 1. The coating films produced were evaluated in the same manner.

The evaluation results obtained in the above examples and comparative example are shown in Table 1.

TABLE 1

| | | | | | | | | Compar. |
|---|---|---|---|---|---|---|---|---|
| | | | Example | | | | | Ex. |
| | | | 1 | 2 | 3 | 4 | 5 | 1 |
| Combination | Interme- | Film- | Amido | Amido | Acrylic | Acrylic | Amido | Amido |
| of coating | diate | forming | group- | group- | resin | resin | group- | group- |
| composition | coating | resin | containing | containing | varnish 3 | varnish 3 | containing | containing |
| | | | acrylic | acrylic | | | acrylic | acrylic |
| | | | resin | resin | | | resin | resin |
| | | | varnish 1 | varnish 1 | | | varnish 1 | varnish 1 |
| | | Aqueous | Aqueous | Aqueous | Aqueous | Aqueous | Aqueous | Not used |
| | | dispersion | dispersion | dispersion | dispersion | dispersion | dispersion | |
| | | | 1 | 2 | 1 | 3 | 1 | |
| | Metallic | Film- | Amido | Amido | Amido | Amido | Acrylic | Amido |
| | base | forming | group- | group- | group- | group- | resin | group- |
| | coating | resin | containing | containing | containing | containing | varnish 3 | containing |
| | | | acrylic | acrylic | acrylic | acrylic | | acrylic |
| | | | resin | resin | resin | resin | | resin |
| | | | varnish 1 | varnish 1 | varnish 2 | varnish 2 | | varnish 1 |
| | | Aqueous | Aqueous | Aqueous | Aqueous | Aqueous | Aqueous | Aqueous |
| | | dispersion | dispersion | dispersion | dispersion | dispersion | dispersion | dispersion |
| | | | 1 | 2 | 1 | 3 | 1 | 1 |

| | | | | | | | |
|---|---|---|---|---|---|---|---|
| | Clear coating | Solvent- | Solvent- | Water- | Powder- | Solvent- | Solvent- |
| | | base 1 | base 2 | base | form | base 1 | base 1 |
| Evaluation | Feeling of imbibing | ◯ | ◯ | ◯ | ◯ | ◯ | X |
| results | Wave Scan | ◯ | ◯ | ◯ | ◯ | Δ | X |
| | Tension meter | ◯ | ◯ | ◯ | ◯ | Δ | X |

As the results of the examples according to the invention indicate, it is considered that those viscosity levels which are optimal for the workability are attained between the respective coating films as a result of interaction, in specific quantity ratios, of the amide groups of the amide group-containing acrylic resin particles in aqueous dispersion as contained in the water-based intermediate coating, the amide groups and other functional groups of the film-forming resin contained in the water-based metallic base coating and the amide groups of the amide group-containing acrylic resin particles in aqueous dispersion.

It is also presumable that the occurrence of amide groups not only provides hydrophilicity but also increases the cohesive force of resins and improves the dispersibility of metal pigments.

1. A method of forming a coating film by forming, on a substrate provided with an electrodeposited coating film, an intermediate coating film using a water-based intermediate coating, a metallic base coating film using a water-based metallic base coating and a clear coating film using a clear coating in that order,
wherein the water-based intermediate coating comprises an aqueous dispersion of amide group-containing acrylic resin particles obtained by emulsion polymerization of an amide group-containing, ethylenically unsaturated monomer with another ethylenically unsaturated monomer or monomers,
said resin particles having a particle diameter of 0.01 to 1.0 μm.

2. The method of forming a coating film according to claim 1,
wherein said water-based metallic base coating comprises an aqueous dispersion of said amide group-containing acrylic resin particles.

3. The method of forming a coating film according to claim 1 or 2,
wherein said water-based metallic base coating comprises an amide group-containing acrylic resin prepared by solubilizing, with a base, an acrylic resin in water,
said acrylic resin being obtained by solution polymerization of 5 to 40% by weight of an amide group-containing, ethylenically unsaturated monomer, 3 to 15% by weight of an acidic group-containing, ethylenically unsaturated monomer and 10 to 40% by weight of a hydroxyl group-containing, ethylenically unsaturated monomer, and the rest of another ethylenically unsaturated monomer or monomers.

4. The method of forming a coating film according to any of claims 1 to 3,
wherein the clear coating is a solvent-base one, a water-based one or a powder-form one.

5. The method of forming a coating film according to any of claims 1 to 4,
wherein, after application of the water-based intermediate coating on a substrate provided with an electrodeposited coating film, the water-based metallic base coating is applied without curing the intermediate coating film, and the clear coating is applied without curing the intermediate and metallic base coating films.

6. A multi-layer coating film obtainable by the method according to any of claims 1 to 5.
